(19) United States
(12) Patent Application Publication
(10) Pub. No.: US 2016/0032952 A1
(43) Pub. Date: Feb. 4, 2016

(54) QUICK RELEASE BLIND FASTENER

(71) Applicant: Apple Inc., Cupertino, CA (US)

(72) Inventors: Michael D. McBroom, Leander, TX (US); Daniel L. McBroom, Leander, TX (US)

(21) Appl. No.: 14/446,254

(22) Filed: Jul. 29, 2014

Related U.S. Application Data
(63) Continuation of application No. PCT/US14/48672, filed on Jul. 29, 2014.

(51) Int. Cl. F16B 5/06

(52) U.S. Cl. CPC F16B 5/06

(57) ABSTRACT

This application relates to a magnetically actuated fastener suitable for use within an electronic device housing having a first housing component and a second housing component. The magnetically actuated fastener can be attached to the first housing component and includes a spring-loaded magnetically attractable plunger that can be moved longitudinally within a fastener body from an engaged state to a disengaged state by applying a magnetic field through an outer wall of the first housing component. When the magnetically attractable plunger is in the engaged state, the plunger causes locking members to extend radially out of the fastener body to engage a channel defined by the second housing component.

### CROSS REFERENCE TO RELATED APPLICATIONS

This application is a continuation of International Application No. PCT/US14/48672, with an international filing date of Jul. 29, 2014, entitled “QUICK RELEASE BLIND FASTENER,” which is incorporated herein by reference in its entirety for all purposes.

### FIELD

The described embodiments relate generally to methods and apparatus for fastening housing components together without leaving a visible fastening point. More particularly, the present embodiments relate to ways for magnetically engaging and disengaging housing components from each other.

### BACKGROUND

A housings formed form multiple housing components allow convenient access to interior portions of the housing by virtue of being able to remove at least one housing component, which can provide convenient access to internal device components during both assembly and rework applications. Unfortunately, when a number of housing components are joined to form the housing, fasteners used to join the housing components generally cause at least one of two problems. In some cases the fasteners remain visible after the various housing components are joined. For example, a screw head may be left visible along an outside surface of the housing. This can prevent a sleek and unbroken cosmetic surface from being achieved. In other cases, the housing components are joined in permanent or at least semi-permanent manners, such as by adhesively coupling the housing components together. Such a joining method can require lengthy disassembly processes and in some cases cause irreparable damage to the housing.

### SUMMARY

This paper describes various embodiments that relate to ways of fastening a number of housing components together without leaving an exposed fastener.

A magnetically actuated fastener is disclosed. The magnetically actuated fastener includes at least the following elements: a fastener body defining an interior channel disposed along a longitudinal axis of the fastener body; a biasing member coupled to a first end of the interior channel; a magnetically attractable plunger disposed within the interior channel and biased towards the second end of the interior channel by the biasing member; and a locking member that protrudes from an exterior surface of the fastener body when the magnetically attractable plunger is disposed at the second end of the interior channel, and can be retracted into an interior of the fastener body when the magnetically attractable plunger is disposed at the first end of the interior channel.

An electronic device housing is disclosed. The portable electronic device housing includes at least the following: a first housing component; a magnetically actuated fastener coupled to the first housing component, the magnetically actuated fastener including: a fastener body defining an interior channel, a biasing member coupled to a first end of the interior channel, a magnetically attractable plunger disposed within the interior channel and biased towards the second end of the interior channel by the biasing member, and a locking member that extends from an exterior surface of the fastener body when the magnetically attractable plunger is disposed at the second end of the interior channel, and can be retracted into an interior of the fastener body when the magnetically attractable plunger is disposed near the first end of the interior channel; and a second housing component that includes a wall that defines an aperture having a shape and size in accordance with the magnetically actuated fastener, the wall also defining a recess that receives a portion of the locking member when the fastener body is disposed within the aperture and the locking member is extended.

A method of magnetically decoupling a first housing component from a second housing component is disclosed. The method includes at least the following steps: receiving a magnetic field through an outer wall of the first housing component at a magnetically attractable plunger of a magnetically actuated fastener; compressing a biasing member of the magnetically actuated fastener with the magnetically attractable plunger in response to the received magnetic field; and retracting a plurality of locking members into a fastener body of the magnetically actuated fastener in response to a mechanical force applied to the magnetically actuated fastener.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1D show how a portable computing device suitable for use with the described embodiments can be utilized with a number of magnetically actuated fasteners;

FIG. 2 shows a partial cross-sectional perspective view of a magnetically actuated fastener in a disengaged state;

FIG. 3 shows a partial cross-sectional perspective view of a magnetically actuated fastener disposed within an aperture of a housing component while maintaining a disengaged state;

FIGS. 4A-4B show partial cross-sectional perspective views of a magnetically actuated fastener in an engaged state;

FIG. 5 shows a perspective view of a computing device suitable for use with the described embodiments; and

FIG. 6 shows a flow chart representing a method for magnetically actuating a magnetically actuated fastener.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

In certain product categories, fit and finish of a device can be a distinguishing feature that causes consumers to choose one device over another. One way to provide a superior fit and finish to electronic devices is by designing a product housing with a minimal number of seams and/or fasteners showing. By obscuring the fasteners appearing along an exterior surface of the housing, a much smoother and more seamless appearance can be achieved. Unfortunately, when disengaging features of the fasteners are not visible (in some instances being referred to as blind fasteners) the fasteners tend to be substantially more difficult to remove. In some cases, a fastener cover of some sort might need to be removed prior to disengaging such a fastener. A hidden fastener that can be quickly disengaged without removing any sort of obstruction would make disassembly of such a housing substantially more efficient.

One solution to this problem is to couple a first housing component and a second housing component of a housing together with a magnetically actuated fastener. The magnetically actuated fastener can include a spring-loaded magnetically attractable plunger that can be moved longitudinally within a fastener body from an engaged state to a disengaged state by applying a magnetic field through an outer wall of an enclosure associated with the magnetically actuated fastener. When the magnetically attractable plunger is in the engaged state, the plunger causes locking members to extend radially out of the fastener body to engage a channel defined by the second housing component.

In some embodiments, the magnetically actuated fastener can be at least semi-permanently attached to an inside-facing surface of the first housing component so that the magnetically actuated fastener is disposed entirely within the housing. The magnetically actuated fastener can be configured to remain in the engaged state and fastened to the second housing component until acted upon by a magnetic field. Because the magnetic field is used only for removal of the fastener, a permanent magnet need not be implemented in a design of the housing; however, it should be noted that in some embodiments a permanent magnet could be integrated into the magnetically attractable plunger. In the engaged state, the magnetically attractable plunger of the magnetically actuated fastener is positioned in an interior channel defined by the fastener body and fixed in place at one end of the interior channel by a biasing member such as a spring. When a magnet is placed upon a surface of the first housing component the magnetic field can cause the magnetically attractable portion to compress the biasing member. The compression is applied when the magnetically attractable portion moves along the interior channel and towards the surface of the first housing component as a result of a magnetic coupling between the magnetically attractable portion and the magnetic field. As the magnetically attractable portion moves along the interior channel a recess defined by the magnetically attractable portion shifts towards a central portion of the channel. The central portion of the interior channel passes by at least one opening that extends radially through the fastener body and out of an external surface of the fastener body. The opening is operative as a bearing for a locking member that engages a channel defined by the second housing component. When a position of the recess coincides with the position of the opening the locking member can be disengaged from the channel of the second housing component. When the magnet is moved away from the magnetically attractable portion the magnetic coupling is severed, allowing the magnetically attractable portion to shift away from the surface of the first housing component, which causes the locking member to again be forced into an extended position.

In some embodiments, the magnetically actuated fasteners can be integrally formed with the inside-facing surface of the first housing component. In other configurations, the magnetically actuated fasteners can be removably coupled to interior features of the housing component. While, only a single magnetically actuated fastener has been discussed it should be noted that in some embodiments, multiple magnetically actuated fasteners can be employed and require multiple magnets to be concurrently applied to the housing component before the first and second housing components can be separated.

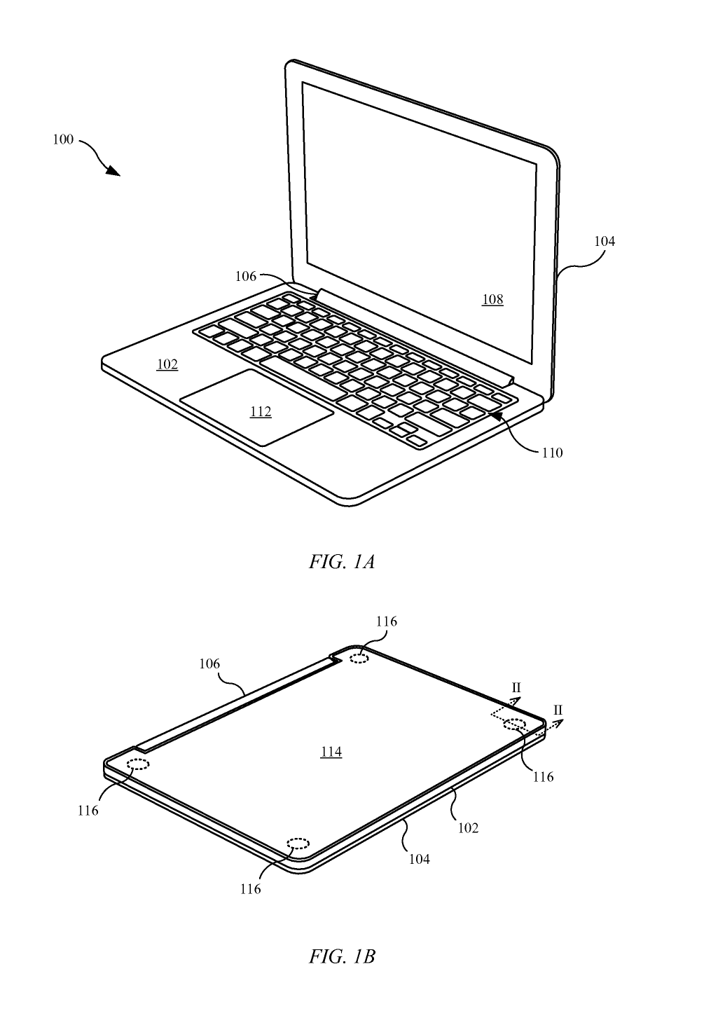

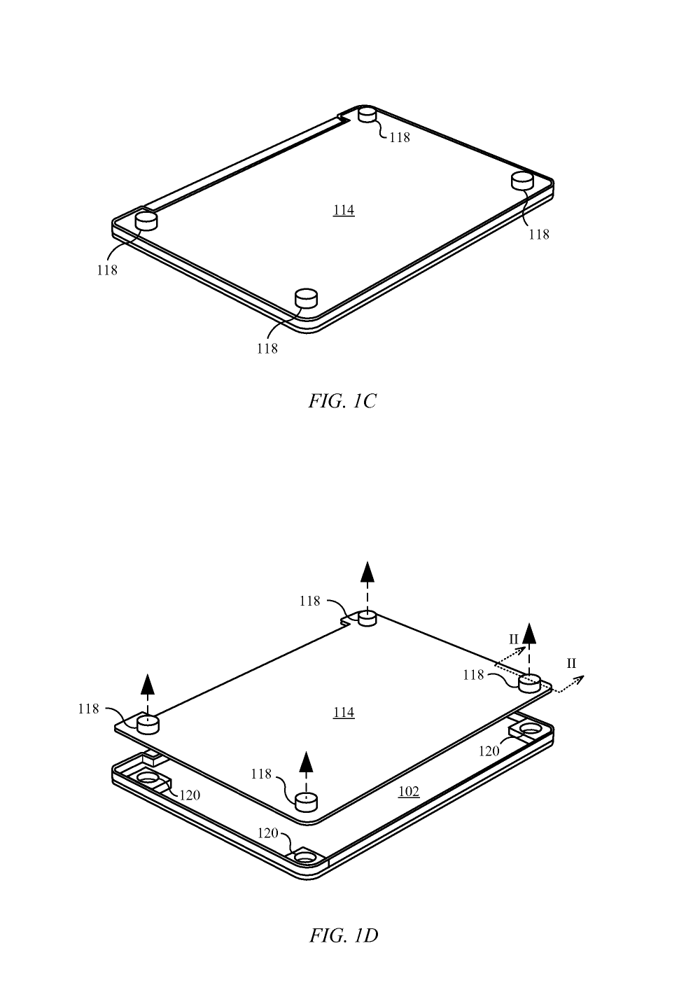

These and other embodiments are discussed below with reference to FIGS. 1A-6; however, those skilled in the art will readily appreciate that the detailed description given herein with respect to these figures is for explanatory purposes only and should not be construed as limiting.

FIG. 1A shows an exemplary portable computing device 100 suitable for use with the described embodiments. Portable computing device 100 includes one housing component that takes the form of base 102 pivotally coupled to lid 104 by hinge assembly 106. Lid 104 can include a number of electrical components that include at least circuitry for supporting display assembly 108. In some embodiments, lid 104 can also include internal antennas for sending and receiving wireless signals. Base 102 can include a number of user interface components such as keyboard 110 and track pad 112 with which a user can interact with portable computing device 100. FIG. 1B shows a perspective view of a bottom portion of portable computing device 100. In particular, a housing component taking the form of bottom cover 114 is depicted, which is operable to close an opening leading into base 102. Dashed ellipses 116 indicate a position of a number of magnetically actuated fasteners disposed within base 102. In some embodiments the magnetically actuated fasteners can be at least semi-permanently joined to inside facing surface of bottom cover 114.

FIG. 1C shows another perspective view of portable computing device 100 and how magnets 118 can be positioned at locations along bottom cover 114 corresponding to dashed ellipses 116 depicted in FIG. 1B. By placing magnets 118 at these positions, magnetic fields emanating from magnets 118 can interact with magnetically attractable portions of the magnetically actuated fasteners to disengage the magnetically actuated fasteners. In some embodiments, bottom cover 114 can include indicia that indicate a position at which magnets 118 should be placed to disengage the magnetically actuated fasteners of portable computing device 100. In other embodiments, no indicia may be present. A lack of indicia can discourage disengagement of the housing components by individuals not specifically trained on disassembly of portable computing device. Furthermore, the use of disassembly indicia such as these may detract from an overall look and feel of the portable computing device. In embodiments where no such indicia are present, a magnetic alignment fixturing device can be utilized to indicate a position at which the magnets should be located to disengage the magnetically actuated fasteners. Such a fixturing device can help to place magnets 118 and their associated magnetic fields in locations sufficiently far enough away from electrical components that are unshielded or otherwise susceptible to damage typically caused by magnetic fields. In some embodiments, an attractive force between magnets 118 and magnetically attractable portions of the magnetically actuated fasteners may be great enough to guide or at least bias magnets 118 towards the positions indicated by dashed ellipses 116.

FIG. 1D shows a perspective view of bottom cover 114. In this depiction, base 102 is being removed subsequent to the magnetically actuated fasteners being disengaged by magnets 118. In some embodiments, magnetically actuated fasteners can be formed with or at least coupled to bottom cover 114. In such a configuration, a magnetic coupling between magnets 118 and corresponding magnetically actuated fasteners of base 102 can allow separation of bottom cover 114 from base 102. By applying a lifting force to magnets 118 magnetically engaged with the magnetically actuated fasteners, the lifting force can be transmitted to bottom cover 114, thereby causing separation between bottom cover 114 and base 102. Also depicted in FIG. 1D are apertures 120 which accommodate fastener bodies of the magnetically actuated fasteners and include an engaging channel or at least recesses that can be engaged with retractable locking members of the magnetically actuated fasteners. In this way, the magnetically actuated fasteners can be coupled to walls of base 102 that define apertures 120. While magnets 118 are depicted as individual magnets 118, it should be noted that in some embodiments magnets 118 could be integrated into a single disassembly mechanism that fixes a relative distance between the magnets so that upon finding an appropriate position for one of magnets 118, appropriate positions for the others can be quickly located. Even more beneficially, the disassembly mechanism can provide a convenient handhold or grip for applying a removal force upon bottom cover 114.

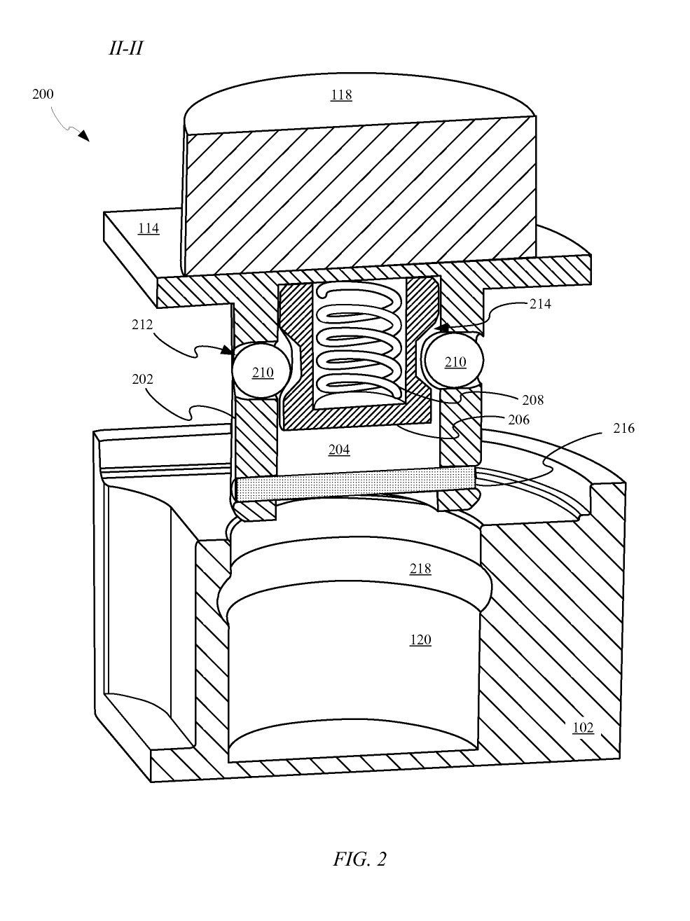

FIGS. 2-4B show a number of views of a magnetically actuated fastener 200. It should be noted that a magnetically actuated fastener can also be constructed in many other manners. FIG. 2 shows a partial cross-sectional perspective view of magnetically actuated fastener 200 in accordance with section line II-II as depicted in FIG. 1D. Magnetically actuated fastener 200 includes a fastener body 202. In the depicted embodiment, fastener body 202 extends from and is integrally formed with an inside-facing surface of bottom cover 114; however, it should be understood that fastener body can be attached to bottom cover 114 in a number of other ways. For example, fastener body 202 can be adhesively coupled, press fit or coupled by a more traditional fastener to the inside-facing surface of bottom cover 114. Fastener body 202 can take the form of a substantially cylindrical protrusion that extends from the inside-facing surface of bottom cover 114. Alternatively, fastener body 202 can take other shapes. For example, by utilizing a polygonal shape an orientation of fastener body 202 with respect to another housing component can be more certain as it restricts rotation of fastener body 202 within aperture 120. Regardless of shape, fastener body 202 can be integrally formed with bottom cover 114 so that interior channel 204 can extend past the inside-facing surface of bottom cover 114. The decreased thickness of bottom cover 114 that this extension yields can improve a strength of a magnetic coupling between magnet 118 and plunger 206, as it creates a smaller air gap between the magnetically coupled components. Interior channel 204 can be sized to accommodate movement of plunger 206 from a first end of interior channel 204 to a second end of interior channel 204. Plunger 206 defines an internal volume for accommodating biasing member 208. Biasing member 208 can be compressed between the first end of interior channel 204 and an internal surface of plunger 206 that defines the internal volume. In this way, biasing member 208 can continuously bias plunger 206 away from bottom cover 114. A magnetic force between magnet 118 and plunger 206 keeps plunger 206 compressing biasing member 208 in this manner.

Also depicted in FIG. 2 are locking members that take the form of ball bearings 210, which are situated in tapered channels 212 that extend through interior and exterior surfaces of fastener body 202. An exterior opening of tapered channels 212 can be sized so that the exterior opening is large enough to allow a portion of ball bearing 210 to extend past the exterior surface of fastener body 202 but small enough to prevent ball bearing 210 from inadvertently falling out of fastener body 202 through the exterior opening. Tapered central region 214 of plunger 206 allows ball bearings 210 to move freely within tapered channels 212 when plunger 206 is in the disengaged position. Tapered central region 214 is sized to allow only a portion of ball bearing 210 to enter interior channel 204. By allowing ball bearings 210 to partially enter interior channel 204, the ball bearings can retract from out of the exterior openings of the fastener body. Also depicted in FIG. 2 is pin 216 that extends across the second end of the interior channel. Pin 216 acts as a stop for plunger 206 when magnetically actuated fastener 200 is in an engaged state, as will be described in further detail below. It should also be noted that the surfaces that define aperture 120 include an engaging channel 218 that facilitates engagement between magnetically actuated fastener 200 and base 102. Alternatives to engaging channel 218 include a series of recesses having a size and shape in accordance with the portion of ball bearings 210 extending out of fastener body 202. In this way, in addition to restricting vertical movement, the coupling between the housing components can also restrict a rotational position of fastener body 202 with respect to base 102. It should also be noted that while only two ball bearings are depicted to be in use with magnetically actuated fastener 200, any number of ball bearings 210 and tapered channels 212 can be utilized.

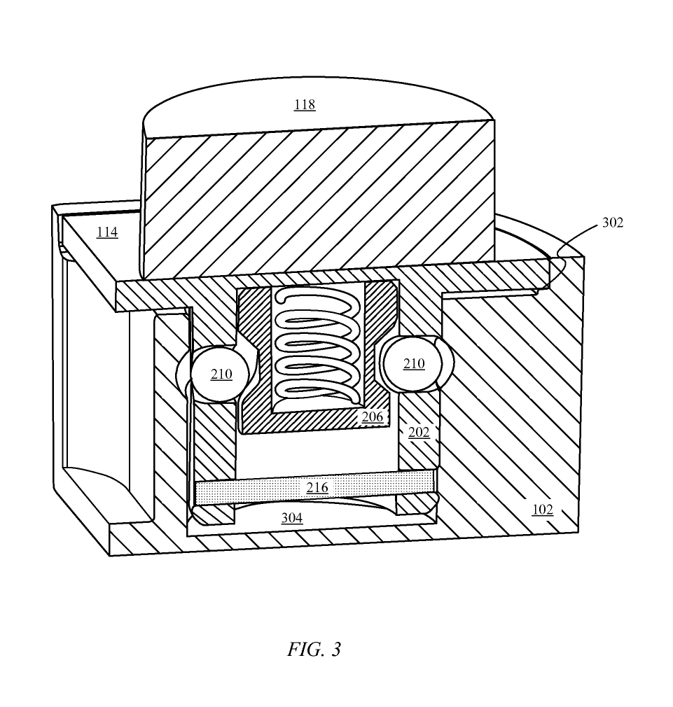

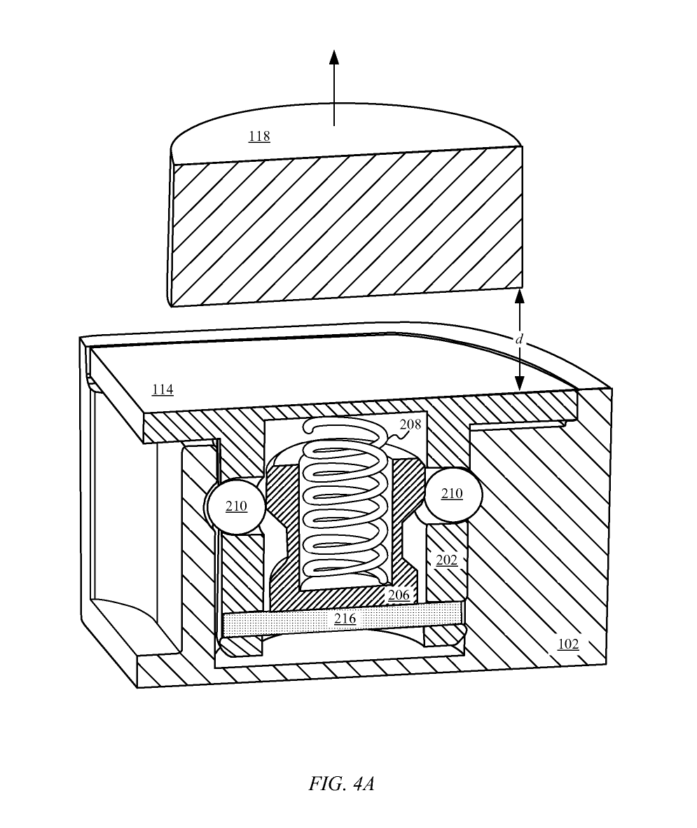

FIG. 3 shows how when bottom cover 114 is seated within aperture 120, tapered channels 212 align with engaging channel 218. This alignment between the channels can be facilitated in any of a number of ways, including for example, defining a lip 302 of base 102 that contacts an inside surface of bottom cover 114 to facilitate the alignment. In some embodiments, a bottom surface of fastener body 202 can be configured to contact a bottom surface 304 of base 102 that defines aperture 120. In this way, the channels can be successfully aligned by fully engaging the bottom surface of fastener body 202 with bottom surface 304. Because magnet 118 is still magnetically coupled with plunger 206, ball bearings 210 are free to maneuver within tapered channels 212 of fastener body 202. It should be noted that while magnet 118 is shown being positioned along bottom cover 114 when magnetically actuated fastener 200 is inserted into aperture 120, in some embodiments magnetically actuated fastener 200 can be pressed directly into aperture 120 without the use of magnet 118.

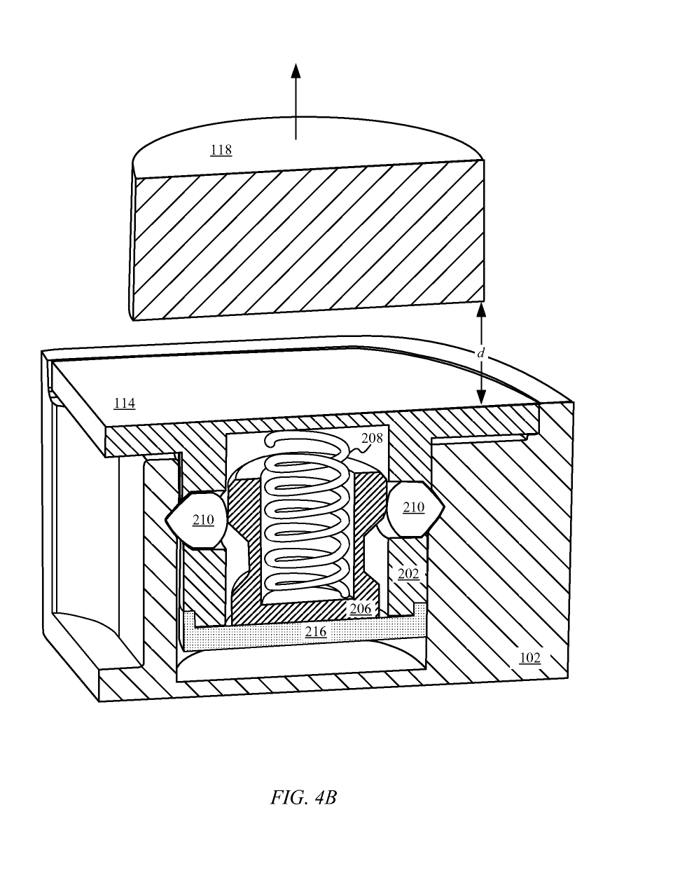

FIGS. 4A-4B shows how magnetically actuated fastener 200 engages base 102 when magnet 118 is removed. FIG. 4A shows how magnetically actuated fastener 200 is engaged with base 102 when magnet 118 is moved a distance d away from a surface of bottom cover 114. By moving magnet 118 away from bottom cover 114 the magnetic coupling between magnet 118 and plunger 206 is reduced below a force at which biasing member 208 overcomes the magnetic coupling and begins moving plunger 206 towards pin 216. Consequently, as shown in FIG. 4A, plunger 206 slides away from bottom cover 114 and into contact with pin 216. Movement of plunger 206 towards pin 216 causes a portion of plunger 206 having a larger diameter to contact ball bearings 210. Contact between plunger 206 and ball bearings 210 causes ball bearings 210 to be locked and engaged with engaging channel 218. While magnet 118 is shown moving away from plunger 206 in a vertical direction, magnet 118 can also be displaced away in a lateral direction, which also causes engagement of ball bearings 210 with engaging channel 218. Also depicted in FIG. 4A is how plunger 206 is held in position by pin 216 and biasing member 208 in the engaged state. In this way, plunger 206 is prevented from sliding past ball bearings 210 and ultimately leaving fastener body 202.

In some embodiments, pin 216 can take other forms. For example, FIG. 4B shows how pin 216 can take the form of an end cap. End cap 216 can be engaged with fastener body 202 after insertion of plunger 206 and biasing member 208 into interior channel 204. The end cap, like pin 216 is also configured to provide a firm stop that causes plunger 206 to stop in a predetermined position within fastener body 202. By fixing a position of plunger 206 with respect to bottom cover 114, a magnitude of a magnetic coupling between plunger 206 and magnet 118 prior to disengagement can be known given a magnet of known strength. In this way, a strength of magnet 118 can be optimized with enough strength to overcome a biasing force provided by biasing member 208 when magnet 118 is in contact with and disposed above plunger 206. It should be noted that end cap 216 can be coupled to fastener body 202 in many ways. For example, end cap can include internal threading complementary to threading disposed around an outside surface of fastener body 202. Alternatively, the end cap can be adhesively coupled to fastener body 202. Subsequent removal of bottom cover 114 can be accomplished by reapplying magnet 118 to bottom cover 114, thereby allowing locking members 210 to be disengaged from engaging channel 218. It should also be noted that FIG. 4B depicts locking members 210 having a different shape than previously depicted ball bearings 210. For example, locking members 210 depicted in FIG. 4B have a non-spherical shape that extends out of fastener body 202. As depicted the protruding portion of locking members 210 can be cone-shaped or even wedge shaped. As long as locking members have a shape that includes some kind of tapered or curved surface that causes the locking members to retract into fastener body 202 in response to a lifting force being applied to bottom cover 114 the alternative shapes are likely compatible with the described embodiments. Locking members 210 should also generally include a curved or at least slanted interior-facing surface to facilitate interaction between locking members 210 and plunger 206.

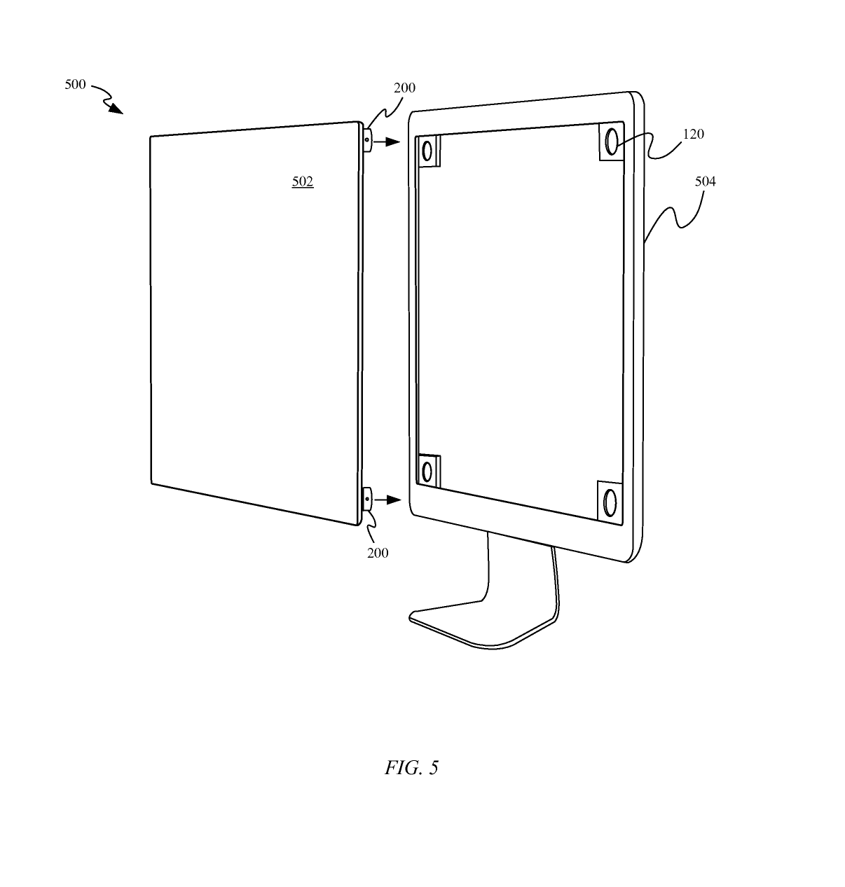

FIG. 5 shows a side perspective view of electronic device 500, which is also suitable for use with a magnetically actuated fastener. In some embodiments, electronic device 500 can be a monitor that receives signals from an external electronic device, while in other embodiments electronic device 500 can include computing circuitry along the lines of circuit boards, processors and memory modules that can all cooperate to drive a display device. Display cover 502 includes a number of magnetically actuated fasteners 200 that can be formed along an inside facing surface of display cover 502. In some embodiments, display cover 502 can be a transparent substrate and fastener body 202 can be formed from a plastic material formed along the inside facing surface. In other embodiments, a metal frame can be adhered to the inside facing surface to create a robust coupling between display cover 502 and fastener body 202. Apertures 120 can be defined by surfaces within housing 504 of electronic device 500. In some embodiments, apertures 120 can be thin rings past which ball bearings can be extended, thereby preventing the magnetically actuated fasteners from moving back out of apertures 120 until a number of magnets are utilized to disengage the magnetically actuated fasteners. Engaging and disengaging of the magnetically actuated fasteners can work in much the same way as the embodiment depicted in FIGS. 2A-4.

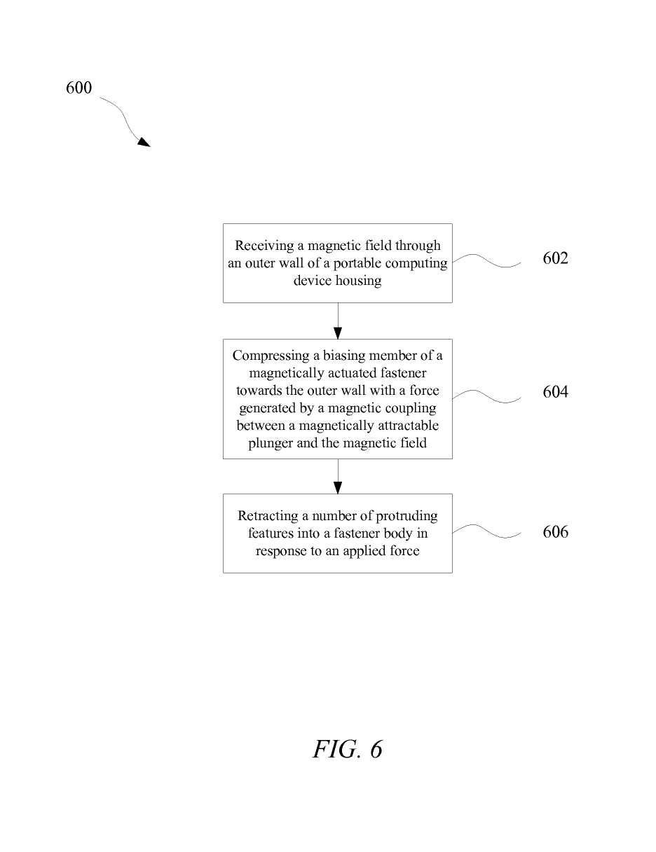

FIG. 6 shows a flow diagram representing a method for unlatching a first housing component from a second housing component coupled together by at least one magnetically actuated fastener. In a first step 602, a plunger of a magnetically actuated fastener is magnetically coupled with a magnetic field emitted by an external magnet positioned along an exterior surface of the portable computing device. At step 604, the magnetic coupling causes the plunger to move along an interior channel of the magnetically actuated fastener in a manner that compresses a biasing member also disposed within the interior channel towards the external magnet. As described above the plunger can have a tapered central region, each end of the plunger having a larger size than the tapered central region. The ends can have a diameter that substantially corresponds to a width of the interior channel. The movement of the plunger causes the tapered central region of the plunger to be positioned adjacent to openings that include ball bearings. At step 606, the tapered central region allows a portion of each of the protruding features or ball bearings to partially enter the interior channel so that the ball bearings can retract into a fastener body of the magnetically actuated fastener. In this way, the housing components can be disengaged from one another.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A magnetically actuated fastener, comprising:
a fastener body defining an interior channel disposed along a longitudinal axis of the fastener body;
a biasing member coupled to a first end of the interior channel;
a magnetically attractable plunger disposed within the interior channel and biased towards the second end of the interior channel by the biasing member; and
a locking member that protrudes from an exterior surface of the fastener body when the magnetically attractable plunger is disposed at the second end of the interior channel, and can be retracted into an interior of the fastener body when the magnetically attractable plunger is disposed at the first end of the interior channel.

2. The magnetically actuated fastener as recited in claim 1, wherein the magnetically attractable plunger compresses the biasing member and moves towards the first end of the interior channel in response to a magnetic field being applied proximate the first end of the interior channel.

3. The magnetically actuated fastener as recited in claim 1, wherein the biasing member comprises a spring.

4. The magnetically actuated fastener as recited in claim 1, wherein an outside surface of the magnetically attractable plunger defines a recess that allows the locking member to retract into the fastener body when the magnetically attractable plunger is at the first end of the interior channel.

5. The magnetically actuated fastener as recited in claim 1, wherein a first and second end of the magnetically attractable plunger have a first outer diameter and a central portion of the magnetically attractable plunger has a second diameter smaller than the first diameter.

6. The magnetically actuated fastener as recited in claim 1, wherein the locking member comprises a ball bearing disposed within a tapered channel that extends radially through an outer wall of the fastener body.

7. The magnetically actuated fastener as recited in claim 6, wherein a thickness of the outer wall of the fastener body is less than a diameter of the ball bearing.

8. The magnetically actuated fastener as recited in claim 7, wherein a tapered portion of the tapered channel prevents the ball bearing from passing through the tapered portion and being separated from the fastener body.

9. The magnetically actuated fastener as recited in claim 6, further comprising a plurality of locking members.

10. An electronic device housing, comprising:
a first housing component;
a magnetically actuated fastener coupled to the first housing component, the magnetically actuated fastener comprising:
a fastener body defining an interior channel,
a biasing member coupled to a first end of the interior channel,
a magnetically attractable plunger disposed within the interior channel and biased towards the second end of the interior channel by the biasing member, and
a locking member that extends from an exterior surface of the fastener body when the magnetically attractable plunger is disposed at the second end of the interior channel, and can be retracted into an interior of the fastener body when the magnetically attractable plunger is disposed near the first end of the interior channel; and
a second housing component, comprising a wall that defines an aperture having a shape and size in accordance with the magnetically actuated fastener, the wall also defining a recess that receives a portion of the locking member when the fastener body is disposed within the aperture and the locking member is extended.

11. The electronic device housing as recited in claim 10, wherein the magnetically actuated fastener further comprises an end cap that engages a protruding end of the fastener body and defines the second end of the interior channel.

12. The electronic device housing as recited in claim 10, wherein the magnetically attractable plunger moves from the second end of the interior channel towards the first end of the interior channel in response to a magnetic field applied by a magnet at an outside surface of the first housing component.

13. The electronic device housing as recited in claim 10, wherein the magnetically actuated fastener is integrally formed with the first housing component.

14. The electronic device housing as recited in claim 13, wherein the first end of the interior channel extends past an inside-facing surface of the first housing component.

15. The electronic device housing as recited in claim 10, wherein the biasing member comprises a spring.

16-20. (canceled)

21. A computing device, comprising:
a first housing component;
a second housing component; and
a magnetically actuated fastener fixedly joined to an interior facing surface of the first housing component, the magnetically actuated fastener configured to transition from a locked state in which it secures the first housing component to the second housing component, to an unlocked state in which the first housing component can be separated from the second housing component in response to an externally applied magnetic field, the magnetically actuated fastener comprising a fastener body defining an interior channel disposed along a longitudinal axis of the fastener body, a biasing member coupled to a first end of the interior channel, and a magnetically attractable plunger disposed within the interior channel and biased towards the second end of the interior channel by a biasing member.

22. The computing device as recited in claim 21, wherein the magnetically actuated fastener further comprises a locking member.

23. The computing device as recited in claim 22, wherein the locking member protrudes through an exterior surface of the fastener body when the magnetically actuated fastener is in a locked state.

24. The computing device as recited in claim 22, wherein the locking member is forced to protrude through an exterior surface of the fastener body when the magnetically attractable plunger is disposed at the second end of the interior channel.

25. The computing device as recited in claim 24, wherein the locking member is forced to protrude through the exterior surface of the fastener body by an exterior surface of the magnetically attractable plunger when the magnetically attractable plunger is disposed at the second end of the interior channel.
